(19) United States
(12) Patent Application Publication
(10) Pub. No.: US 2010/0162120 A1
(43) Pub. Date: Jun. 24, 2010

(54) Digital Media Player User Interface

(76) Inventors: Derek Niizawa, Sunnyvale, CA (US); Joseph Halpern, Santa Clara, CA (US); Yaron Sheba, Mountain View, CA (US); Doten Koren, Tel Aviv (IL)

Correspondence Address: BRINKS HOFER GILSON & LIONE/SanDisk, P.O. BOX 10395, CHICAGO, IL, 60610, US

(21) Appl. No.: 12/338,768

(22) Filed: Dec. 18, 2008

(51) Int. Cl. G06F 3/16; G06F 12/00

(52) U.S. Cl. 715/727; 711/115; 711/E12.001

(57) ABSTRACT

A user interface of a digital media player is disclosed. In one embodiment, a digital media player comprises a memory storing a plurality of channels of digital media files and a plurality of background animation files, wherein each channel is associated with a respective background animation file. The digital media player receives a user selection of a channel, displays a channel name of the selected channel, and plays the background animation file associated with the selected channel. In another embodiment, the digital media player receives a user selection of a channel, displays a channel name of the selected channel, and displays a visual representation of the plurality of channels, wherein a first indicia is used to represent the selected channel and a second indicia is used to represent the other channels.

### BACKGROUND

The usage paradigm created for digital audio players in recent years is based upon the ability of the user to identify and select certain audio tracks or collections for download onto their digital audio players. It relies on the ability of a user to actually find what he is looking for. Users who are avid consumers of music but do not rely on specific artist or song knowledge, such as radio listeners, may be left with a frustrating experience. In addition, even those users who are comfortable with operating within this paradigm are faced with complicated devices that require sometimes as many as five menu selection tasks before the playing of music can commence. Many times, a user just wants to power-on a digital audio player and start playing a certain type of music without navigating through various menu levels. Streaming audio solutions, such as Internet radio, solve the audio experience problem and provide a satisfying experience in delivering rich content with simplicity. However, this is only available in network-connected environments, and PCs and some digital audio players that provide a network connection have user interfaces that can be as, if not more, complicated than the digital audio players described above. Several services, such as Slacker Portable and Rhapsody Channels, emulate a radio-like listening experience on a portable digital audio player by allowing users to select different channels of music. Such services offer a user the ability to listen (with some restrictions) to a large pool of content at a price lower than if the user purchased each individual song. In operation, such services cache a plurality of songs along with a playlist or other mechanism that specifies a predetermined play order of the songs.

### SUMMARY

The present invention is defined by the claims, and nothing in this section should be taken as a limitation on those claims.

By way of introduction, the embodiments described below provide a digital media player user interface. In one embodiment, a digital media player comprises a memory storing a plurality of channels of digital media files and a plurality of background animation files, wherein each channel is associated with a respective background animation file. The digital media player receives a user selection of a channel, displays a channel name of the selected channel, and plays the background animation file associated with the selected channel. In another embodiment, the digital media player receives a user selection of a channel, displays a channel name of the selected channel, and displays a visual representation of the plurality of channels, wherein a first indicia is used to represent the selected channel and a second indicia is used to represent the other channels.

Other embodiments are disclosed, and each of the embodiments can be used alone or together in combination. The embodiments will now be described with reference to the attached drawings.

### BRIEF DESCRIPTION OF THE DRAWINGS

FIG. 1 is a block diagram of a digital media player of an embodiment with embedded memory.

FIG. 2 is a block diagram of a digital media player of an embodiment with a removable memory card.

FIGS. 3A, 3B, 3C, and 3D are illustrations of a digital media player of an embodiment.

FIG. 4 is an illustration of a digital media player of an embodiment showing a user interface of a PS Mode of operation.

FIGS. 5A and 5B are illustrations of a digital media player of an embodiment in a PS Mode of operation when a memory card contains a user channel.

FIG. 6 is an illustration of an exemplary directory of an embodiment containing a top level configuration file.

FIG. 7 is an illustration of an exemplary directory of an embodiment.

FIG. 8 is an illustration of an exemplary channels folder of an embodiment.

FIG. 9 is an illustration of a digital media player of an embodiment in a PL Mode of operation.

FIG. 10 is an illustration of a folder in a PL Mode of operation of an embodiment.

FIG. 11 is an illustration of an exemplary music folder of an embodiment.

FIG. 12 is an illustration of a digital media player of an embodiment in a User-Defined Card Mode of operation.

FIG. 13 is an illustration of a digital media player of an embodiment in an FM Mode of operation.

### DETAILED DESCRIPTION OF THE PRESENTLY PREFERRED EMBODIMENTS

Introduction

By way of introduction, the following embodiments relate to a user interface for a digital media player. Before turning to these embodiments, a general overview of exemplary digital media players is provided.

Exemplary Digital Media Players

In general, a digital media player is a device having a memory (either embedded or removable (e.g., a removable memory card)) that stores digital media files and circuitry for playing those files. The digital media player can comprise other components, such as, but not limited to, a display device, an audio output jack, a speaker, and a wireless transceiver. The memory in the digital media player can take any suitable form, such as, but not limited to, a non-volatile solid-state memory (e.g., flash memory, NAND memory, and multi-level cell (“MLC”) memory), optical memory, and magnetic memory. As used herein, “circuitry” can include one or more components and can be a pure hardware implementation and/or a combined hardware/software (or firmware) implementation. Accordingly, “circuitry” can take the form of one or more of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example. In addition to being operative to play digital media files, the circuitry can be operative to perform other functions, such as, but not limited to, communicating with a host device via a wired or wireless connection, recording digital media files, and managing the operation of the digital media player. While the digital media player can be a device dedicated to playing digital media, it can also be a device that performs various other functions, in which case the circuitry in the player can also be operative to perform those other functions. For example, a digital media player can be part of a mobile phone, a game device, a personal digital assistant (PDA), an email/text messaging device, a digital camera, a personal navigation system (PND), and a mobile Internet device (MID).

Digital media can take any suitable form, such as, but not limited to, audio (e.g., a song, spoken word, a podcast, one or a series of sounds, etc.), video (with or without accompanying audio) (e.g., a movie, an episode of a TV show, a news program, etc.), still or moving images (e.g., a photograph, a computer-generated display, etc.), text (with or without graphics) (e.g., an article, a text file, etc.), and a hybrid multi-media presentation of two or more of these forms. For simplicity, in the following embodiments, the digital media player will take the form of a portable digital audio player. Again, a digital audio player is just one of the many forms a digital media player can take, and the claims should not be read as requiring a digital audio player unless that term is explicitly used therein. Accordingly, these embodiments can be adapted for use with other types of digital media (e.g., digital video).

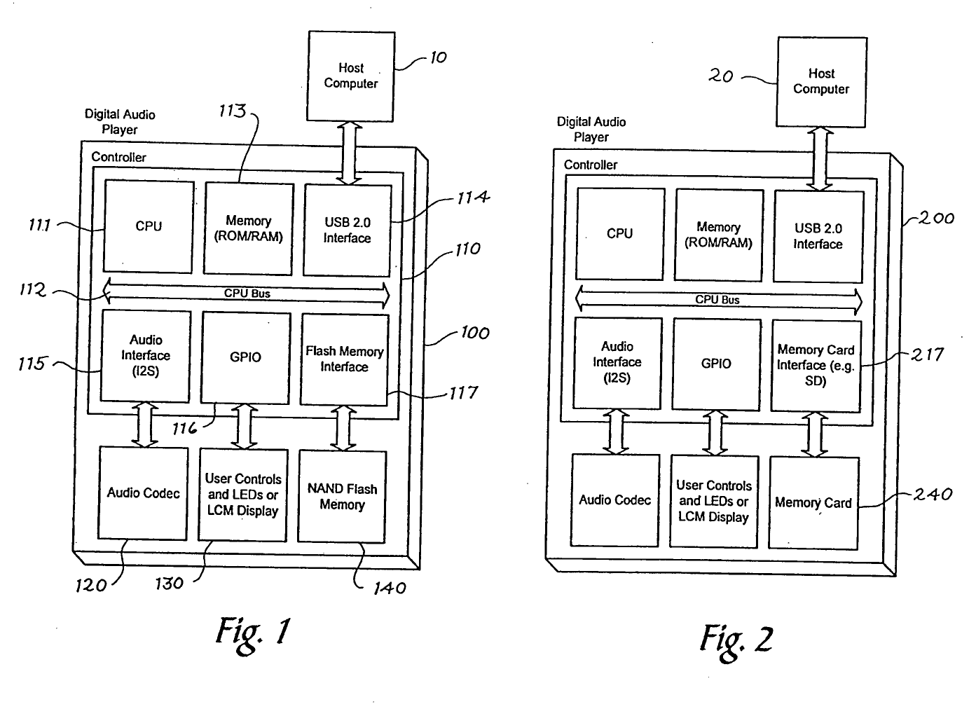

Turning now to the drawings, FIG. 1 is an illustration of a portable digital audio player 100 of an embodiment. As shown in FIG. 1, the digital audio player 100 comprises a controller 110, which, in this embodiment, comprises a central processing unit (CPU) 111 and a CPU bus 112 that places the CPU 111 in communication with several other components in the controller 110: memory (ROM/RAM) 113 (preferably a combination of ROM and RAM (including different configurations of RAM such as SRAM, SDRAM, and 1TSRAM) that stores computer-readable program code (e.g., firmware) executable by the CPU 111 to run the digital audio player 100, a USB 2.0 interface 114 operative to place the digital audio player 100 in communication with a host computer 10, an audio interface 115 (e.g., an I2S interface), general purpose input-output (GPIO) circuitry 116, and a flash memory interface 117. The digital audio player 100 also comprises an audio codec 120, user controls and LEDs or LCM display 130, and an embedded NAND flash memory 140. (While the memory 140 is shown as a single component in FIG. 1, it should be understood that several separate memory components can be used.) The audio codec 120 is in communication with the audio interface 115 and provides audio output through a headphone jack or speakers (not shown). The user controls and LEDs or LCM display 130 provide a user interface through which a user can control the operation of the digital audio player 100 through the GPIO 116, and the NAND flash memory 140 stores digital audio files that the controller 110 receives via the flash memory interface 117 and plays through the audio interface 115 and the audio codec 120.

In this embodiment, the digital audio player 100 receives digital audio files from the host computer 10 in communication with the digital audio player 100 via the USB 2.0 interface 114. As used herein, the phrase “in communication with” means directly in communication with (e.g., through a wired or wireless connection) or indirectly in communication with through one or more components, which may or may not be shown or described herein.) The digital audio player 100 and the host computer 10 can have mating ports, or a cable or cradle can be used to connect the digital audio player 100 with the host computer 10, which downloads digital content to the embedded NAND flash memory 140 in the player 100. The source of the digital audio files can be the host computer 10 itself or an external location in communication with the host computer 10 via a network, such as the Internet.

It should be noted that the digital audio player 100 shown in FIG. 1 is merely one example of a digital audio player, and variations to the components shown in FIG. 1 can be used. For example, in an alternate digital audio player 200 shown in FIG. 2, the flash memory interface 117 and the embedded NAND flash memory 140 are replaced by a memory card interface 217 (e.g., an SD card interface) and a memory card 240 received by the digital audio player 200 via a memory card slot (not shown). In this embodiment, digital audio files can be presented to the digital audio player 200 via a removable memory card 240 instead of or in addition to downloading digital audio files from the host computer 20. In yet another alternative, a digital audio player can have both embedded memory and a removable memory card. Further, instead of the digital audio player having a wired connection to the host computer, the digital audio player can have a wireless transceiver to place the digital audio player in communication with the host computer. With a wireless transceiver, the digital audio player can directly communicate with a networked component without the need to use the host computer. Further, in other embodiments, the digital audio player merely has a memory card slot and does not have a connection to a host device or network. As yet another variation, as indicated in FIGS. 1 and 2, the digital audio player 100, 200 can either have a display device (e.g., an LCM display) or simple LEDs to provide some visual feedback to the user. In an alternate embodiment, neither a display device nor LEDs are used.

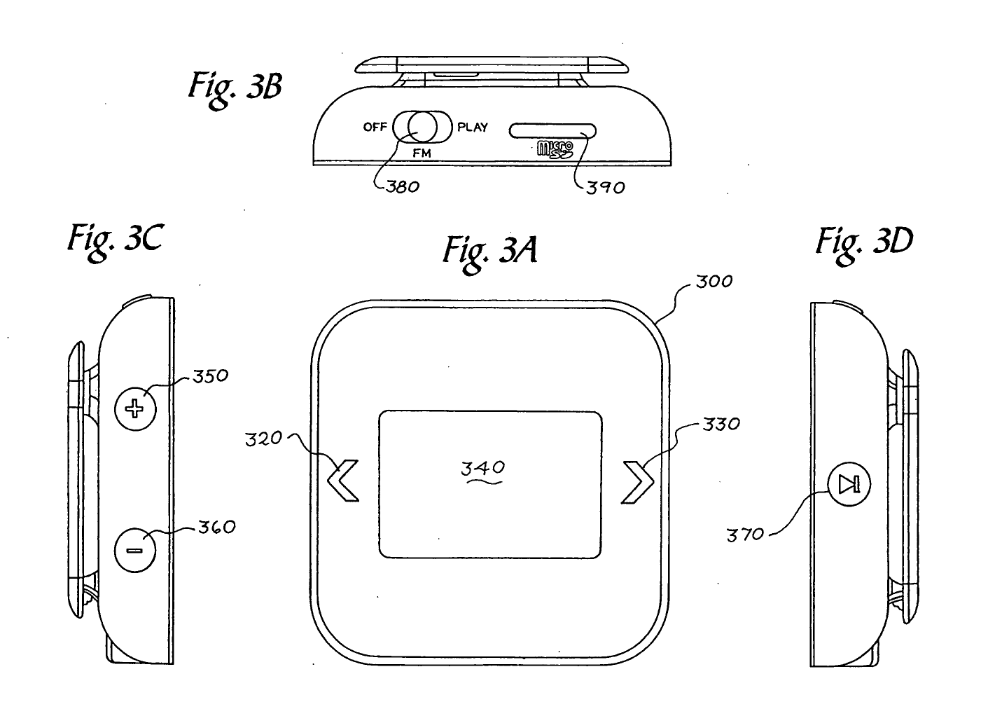

For simplicity, the embodiments described herein will be described in conjunction with the digital audio player 200 of FIG. 2, as further illustrated by FIGS. 3A, 3B, 3C, and 3D. However, it should be noted that the digital audio player 100 of FIG. 1, as well as other types of digital media players, can be used with these embodiments.

Returning to the drawings, FIGS. 3A, 3B, 3C, and 3D are various views of a digital audio player 300 of a presently preferred embodiment. As shown in these figures, the digital audio player 300 has a left arrow button 320 and a right arrow button 330 that allows a user to make a selection. (The user input elements can take other forms, such as, but not limited to, a wheel, a lever, a switch, a knob, or a touch-sensitive element.) For example, as will be described in more detail below, the buttons 320, 330 can act as “change channel” buttons, with the left arrow button 320 indicating “previous channel” and the right arrow button 330 indicating “next channel.” In this way, a user can select a channel with the press of a single button, much like the user's experience with pressing a previous channel or next channel button on an FM radio. The digital audio player 300 also comprises a display device 340 for displaying a user interface, as will be described in more detail below. Additionally, the digital audio player 300 comprises additional user interface buttons such as a volume-up button 350, a volume-down button 360, a “skip song” button 370 (this player 300 does not have a “previous song” button, but one could be added depending on the desirability of such functionality), a switch 380 to select between “Off,” “FM,” and “Play” (or “Card”) modes of operation.

The digital audio player 300 also has a slot 390 for accepting a memory card storing digital media files and playlists. Preferably, the digital media files and playlists are stored in a secure fashion in the memory card to prevent unauthorized use or tampering. In a presently preferred embodiment, a TrustedFlash™ architecture from SanDisk Corporation is used to store the digital media files and playlists in a hidden partition on the memory card. Further information about TrustedFlash™ can be found in U.S. patent application Ser. No. 11/314,411 (published as U.S. patent publication 2006/0242068A1), Ser. Nos. 11/557,028, and 11/322,812 (published as U.S. patent publication 2007/0043667A1), which are assigned to the assignee of the present application and hereby incorporated by reference. Preferably, although not required, in this embodiment, the memory card does not contain a general library of digital audio files outside of the files referenced by the playlists.

Further information about exemplary digital media players and methods for use therewith can be found in U.S. patent application Ser. Nos. 11/967,861 and 12/134,664, which are assigned to the assignee of the present application and are hereby incorporated by reference.

Exemplary User Interface

The following paragraphs will describe the visuals and interactions associated with a preferred user interface for a digital media player and, for simplicity, will be described using the digital audio player 300 in FIGS. 3A, 3B, 3C, and 3D. This user interface provides a fundamentally new approach to user interaction with digital media players. Currently, most digital audio players require a series of decisions and selections to be made before one can begin enjoying music. With the user interface of these embodiments, a user is provided with a limited number of channels as the only choices, and, in many situations, allows a user to begin listening to music simply by pressing one button. In another embodiment, a user can select a slotMedia mode, which is automatically selected when a slotMedia card is plugged in but may be navigated away from and then returned to through the main menu.

In this embodiment, the user interface for the digital audio player 300 consists of two modes: a Card Mode and a FM Mode. The Card Mode is separated into three sub-categories depending on what type of memory card is inserted into the slot 390. These three modes are PS (“Powerfully Simple”) Mode, PL (“Pre Loaded”) Mode, and User-Defined Card Mode. (In one presently preferred embodiment, PS Mode works with slotRadio (or slotMix) memory cards, and PL Mode works with slotMusic cards.) Each of these modes and sub-modes will now be described.

PS Mode

In this exemplary embodiment, the PS Mode is entered when the switch 380 is set to the Play position and a PS memory card is inserted into the slot 390. A PS memory card is a memory card that contains two or more pre-defined channels of multiple songs. For example, a memory card can be labeled as a “jazz card” and contain different channels of jazz music (e.g., “Groove Boutique,” “Classic Jazz,” and “Modern Jazz”). As another example, different channels on a memory card can be associated with different genres of music. In this embodiment, each channel is associated with its own plurality of playlists (i.e., a first channel is associated with a first plurality of playlists, a second channel is associated with a second plurality of playlists, etc.). Each of the channels can have unique tracks, such that there is no overlap in songs, or two or more channels can share at least one track between them. More information about the use of playlist can be found in U.S. patent application Ser. Nos. 12/157,844 and 12/157,846, which are assigned to the assignee of the present application and are hereby incorporated by reference. The user interface associated with the PS Mode allows the user to skip between channels with the left and right arrow buttons 320, 330 and can skip to the next song in the current channel by pressing the skip button 370.

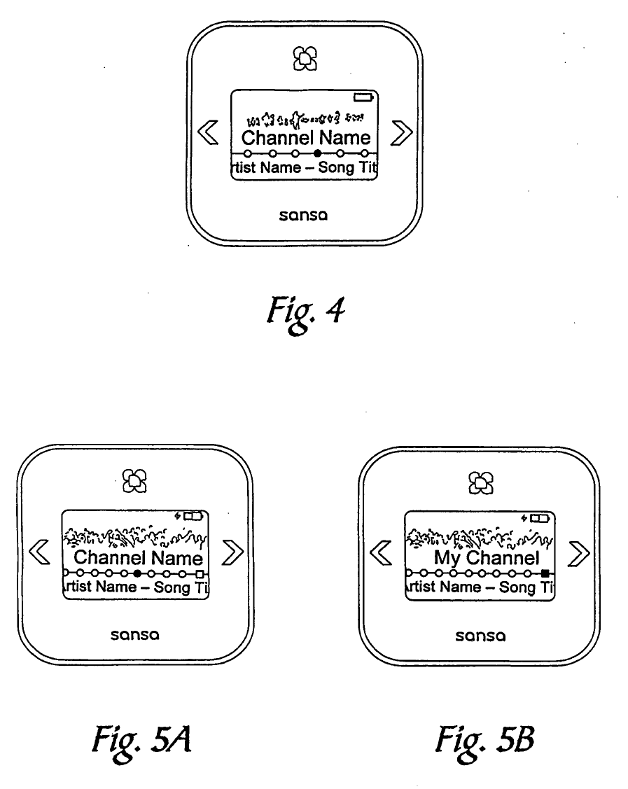

As shown in FIG. 4, the display device 340 can display information that the user may find helpful in navigating between channels and songs. Specifically, the display device 340 displays the channel name, along with a background (e.g., a still image or an animated background) that can be specifically associated with that channel. (While the background is preferably stored on the memory card, it can also be stored on the player 300 itself.) Because each channel has its own background and the display 340 displays both the channel name and the background, the display 340 provides information that should be sufficient to provide a channel identity to the user. This display 340 also displays a bar 400 with six circles, each circle indicating a channel of music on the memory card (in a presently preferred embodiment, there is a minimum of three circles and a maximum of eight circles plus a box for a user-defined channel called “My Channels”). In this embodiment, the selected channel is highlighted with a white dot to show the user where the current channel fits in with the other channels on the memory card. When the user presses the previous channel button 320 or the next channel button 330, the white dot moves to the left or right circle, respectively. In a presently preferred embodiment, when moving between channels, there is a very short shrinking and growing animation sequence of the dot. The display 340 also displays song information about the current song being played (e.g., one or more of song title, artist, album title, etc.), as well as the next song that will be played, so the user can decided whether or not to skip to the next song using the skip button 370.

It should be noted that while six circles are shown in FIG. 4, more or fewer circles can be used depending on the number of channels on the memory card. Further, different geometric shapes and display positions can be used. Accordingly, the details presented herein should not be read into the claims unless explicitly recited therein.

The above example assumed that the memory card had six pre-established channels (i.e., that the memory card only contained channels sold with the memory card). In some embodiments, a user is able to add one or more channels to the memory card. FIGS. 5A and 5B are illustrations of a digital media player of an embodiment in a PS Mode of operation where there is a user channel in the memory card. In this embodiment, the user channel takes the form of a folder labeled “My Channels” inside a 1 GB partition in the memory card. After a user adds music files to the “My Channels” folder, the display displays a box representing a user channel to the right of the pre-established channel circles on the bar. As with switching between channels, the user can use the next channel button 330 to move the white dot down the bar from channel to channel until the “My Channels” box is highlighted. While the songs in the “My Channels” folder can be played in any suitable way, in one embodiment, all content placed inside this folder will play in random order when the “My Channel” is selected. The user can organize content inside the “My Channels” folder by using a sub-folder or by placing files directly on the root menu. The digital audio player 300 can read shuffle all content in the free partition.

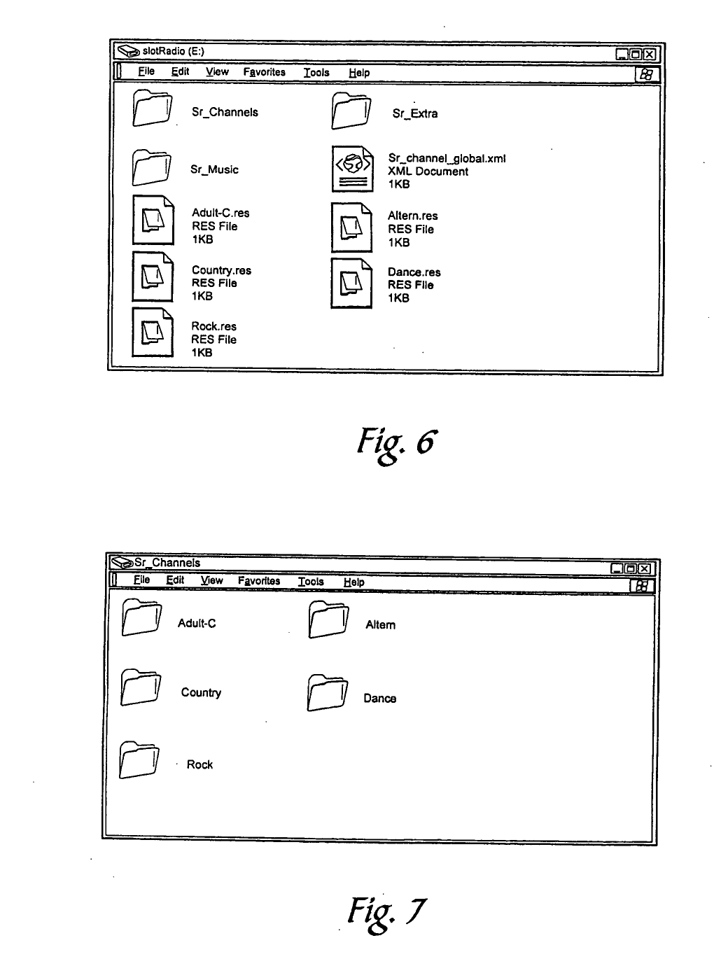

With the general description of the PS Mode user interface now described, the following paragraphs describe a file organization of a presently preferred embodiment. It should be noted that this is merely an example, and other file organizations can be used. In this embodiment, channels on the memory card are virtual and are not tied to the folder structure of the underlying file system. The memory card contains a directory for the music as well as one that defines the channel organization. FIG. 6 is an illustration of an exemplary PS card root directory. All the music from all the channels can be placed in a single directory, and the channel organization can be derived from configuration files and playlists in the channel folder. One advantage of this is that the same song can be used for multiple channels (or multiple playlists within a channel) without duplicating the file and storage requirements.

In this embodiment, the root directory also contains a top level configuration file that defines all the channels on the card. In the example shown in FIG. 6, the folder is named the Sr_channel_global.xml file. The top level configuration file defines the number of channels that will be displayed. For each channel, the top level configuration file also defines the channel title and points to further information about the channel. The digital audio player 300 can quickly determine how many dots to display by counting the number of channels defined in the top level configuration file. The following is an example of a top level configuration file:

```
<?xml version=“1.0” encoding=“UTF-8”?>
<globalContent version=“1”>
  <channelList>
  <channel>
    <title>R&D/Soul/Dance</title>
    <location>Sr_Channels/Dance/</location>
  </channel>
  <channel>
    <title>The Best Of The 60s Rock</title>
    <location> Sr_Channels/Rock/</location>
  </channel>
  </channelList>
</globalContent>
```

In other embodiments, the top level configuration file can be located in the root of the channels folder or other predetermined location. In the example shown in FIG. 7, there are folders for each channel within the channel folder.

When the user presses the right or left arrow buttons 320, 300, the digital audio player 300 moves forward or backwards in the list of channels and accesses the channel information in the appropriate folder.

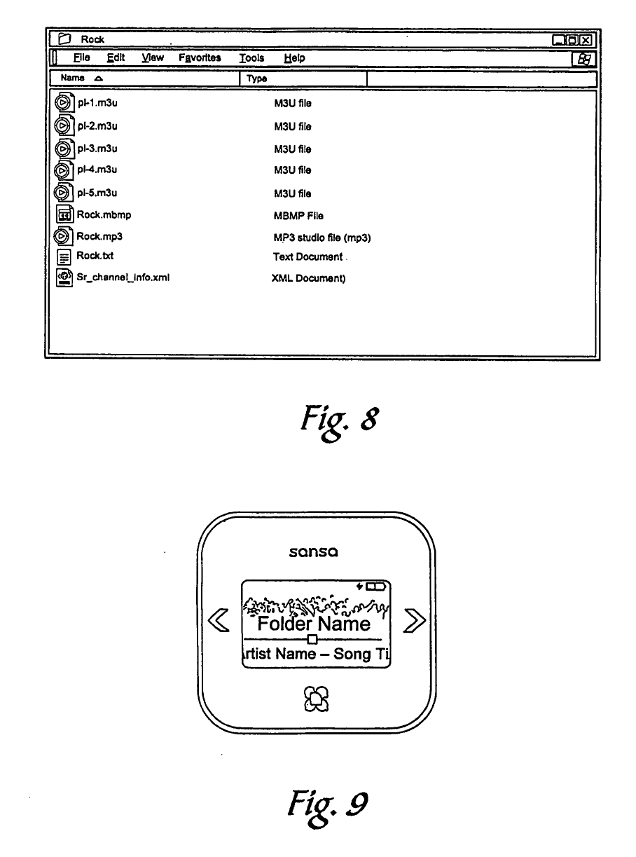

Each channel folder contains zero or more playlists, channel background animations, and a second level configuration file that describes the playlists in the channel. An example content of a channels folder is shown in FIG. 8. An example of a channel configuration file is given below:

```
<?xml version=“1.0” encoding=“UTF-8”?>
<channelContent version=“1”>
  <channelPlaylists>
  <playList>
    <location>pl-1.m3u</location>
  </playList>
  <playList>
    <location>pl-2.m3u</location>
  </playList>
  <playList>
    <location>pl-3.m3u</location>
  </playList>
  </channelPlaylists>
  <artFiles>
    <artFile>
    <location>Rock.mbmp</location>
    </artFile>
  </artFiles>
  <annotation>
    <location>Rock.txt</location>
  </annotation>
</channelContent>
```

Multiple playlists can be used to vary the play order of the songs and even the content of the channel. When all the songs in a playlist have been used, the player 300 can select a new playlist rather than starting over again at the beginning of the same playlist. The selection of the next playlist can be sequential, random, or follow a predetermined iteration pattern. Song information and next song information are data extracted from the ID tags of the song files themselves. The active playlist is used to sequence each song in the channel and to determine the song that will be played next.

The digital audio player 300 uses the channel configuration file to locate “artFiles” or Channel background images of animation. These images can be static (jpegs) or animations (such as multiple bitmaps wrapped in a special .mbmp format, as shown in the example, or other animation types such as motion jpeg (.mov) files). The configuration file can list multiple different resolutions and file formats, and the player 300 can determine which is best for its display needs. The textual information and song progress graphics are overlaid on the background image or animation. The player 300 can use a built-in default animation for a channel if an acceptable background format cannot be found in the channel

Finally, in the root of the memory card is stored bookmark files as shown in the example in FIG. 6. These bookmarks define the last played channel and the current song location (and playlist) for each channel. On power-up of the player 300 or upon card insertion, the user can resume from the same exact spot when playback left off or can change channels and not have to start over again for any channel.

PL Mode

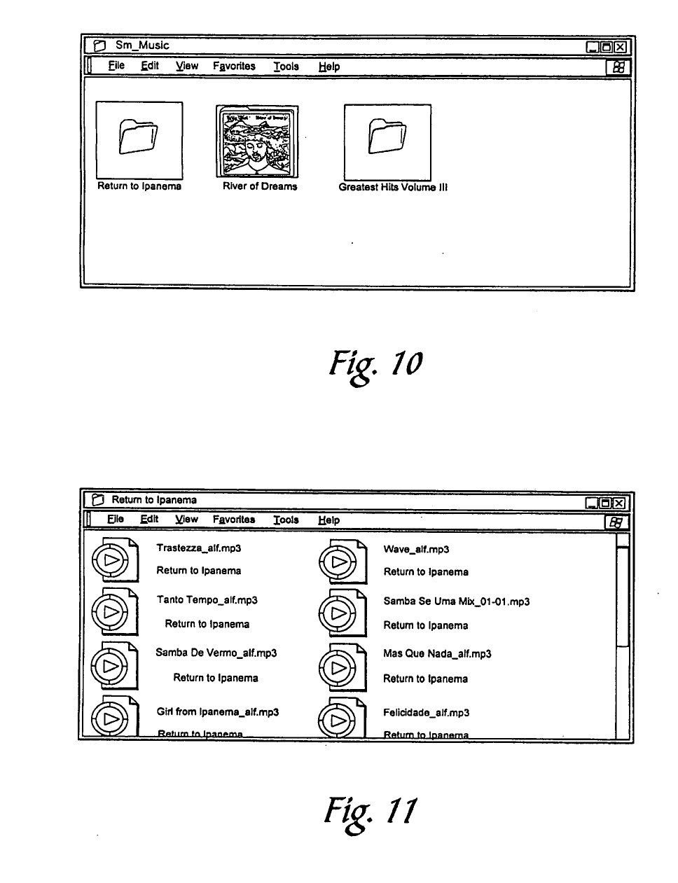

In contrast to the PS Mode, which allows a user to navigate between channels of music on the memory card, navigation in the PL mode is derived from the physical structure of directories on the memory card. FIG. 9 is an illustration of an exemplary user interface when the digital audio player is operating in the PL Mode of operation. The “Folder Name” would be the album name, and a user navigates between folders (albums) by pressing the previous and next buttons 320, 330 and can skip songs in an folder (album) by pressing the skip button 370. The display 340 displays a song progress bar that advances according to the song duration. The display 340 also displays song information (e.g., artist name, song title, etc.) and the next song in the folder (album) on the screen bottom line. As in the PS Mode of operation, background images or animation can be stored on the memory card; here, with each folder (album) having a unique background stored on the memory card.

As mentioned above, in the PL Mode, navigation is derived from the physical structure of directories on the memory card. In one embodiment, the PL memory card has a predetermined directory structure: all music is in a folder in the root directory with a specific name (Sm_Music), and all albums are subdirectories under this folder. FIG. 10 is an illustration of three albums in a “sm_music” folder. Pressing the previous and next buttons 320, 330 advances to the next or previous folder on the card (sorted either alphabetically or by directory order). The name of the second level folder will be displayed as the album name. Similarly, within those music folders, there will be music files and optionally background or animation files. The player 300 can use a built-in default animation if an acceptable background is not found in the second level folder.

FIG. 11 is an illustration of an exemplary music folder. The artist name and song title are extracted from the ID tags embedded in the song itself or the name of the file if these tags are not present. The “next” song is the one next alphabetically or in directory order in the current folder/album. The song progress bar is estimated from file attributes and information stored in the song header. Like the PS Mode, the textual and graphic information is overlaid on the static or animated background image (or default animation if none is found). Also, like the PS Mode, bookmarking can be used to resume playback.

User-Defined Card Mode

In the User-Defined Card Mode, navigation is derived from the physical structure of user-defined directories on the memory card. This embodiment operates similar to the PL Mode except the entire card is scanned for folders containing music and each is used as an album name. Information within an album folder is extracted and displayed similar to the PL Mode. The “next” song in the User-Defined Card Mode is the one next alphabetically or in directory order in the current folder/album. The song progress bar is estimated from file attributes and information stored in the song header, and bookmarking can be used to resume playback.

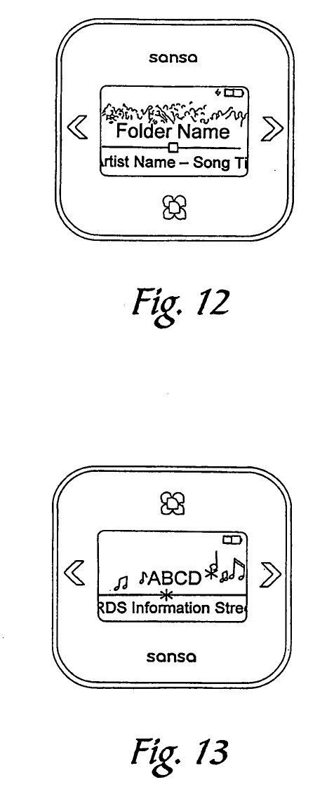

As with the PL Mode, the user navigates between folders using the previous and next buttons 320, 330 and can skip songs in a folder by pressing the skip button 370. As shown in FIG. 12, the display 340 displays a song progress bar that advances according to the song duration. The display 340 also displays song information (e.g., artist name, song title, etc.) and the next song in the folder (album) on the screen bottom line. Background animation files can be stored on a User-Defined memory card, and each folder or album can have a unique background stored on the card. However, background images or animation is less likely to be found in an acceptable format in the User-Defined Card Mode, and the player can use a built-in image or animation if no usable background is found on the memory card. The textual and graphic information is overlaid on the background static or animated image.

When the user reaches the last channel or folder in the list, and player 300 can give feedback by showing a limited slide action showing “no more” channels are available. This will be very helpful in the User-Defined Mode if the user does not organize their music in folders.

FM Mode

A user enters FM Mode by sliding the switch 380 to the FM position. The FM Mode uses FM tuner hardware, and the firmware in the player 300 sets and maintains presets and frequency ranges. The firmware initiates firmware reception at the selected frequency. If Radio Data System (“RDS”) information (such as channel name, artist and song information) is available on a given frequency, it is extracted from over-the-air protocols defined for the RDS standard.

As shown in FIG. 13, in the FM Mode, the player 300 displays an FM tuner bar with the current frequency highlighted and the frequency number displayed on screen center (i.e., ABCD). If RDS information is available, the player 300 can replace the frequency number with the RDS channel name and can scroll RDS artist and song information on the screen bottom line. If RDS information is not available, the player 300 can display the frequency number and a default message. In the FM mode, the player 300 can use a station present animation, such as an asterisk popping up. With some devices, the number of presets may be limited (e.g., nine presets), and FM animated backgrounds can be limited to one style and stored on the player 300 itself instead of a memory card. The background image for FM Mode can be a default built-in image or animation and can be different from the default card animation. The text and graphics are overlaid on the animation.

Conclusion

It should be noted that any of these embodiments can be used alone or in various combinations. Also, it is intended that the foregoing detailed description be understood as an illustration of selected forms that the invention can take and not as a definition of the invention. It is only the following claims, including all equivalents, that are intended to define the scope of this invention. Also, some of the following claims may state that a component is operative to perform a certain function or configured for a certain task. It should be noted that these are not restrictive limitations. It should also be noted that the acts recited in the claims can be performed in any order -not necessarily in the order in which they are recited.

What is claimed is:

1. A method for providing a user interface on a digital media player, the method comprising:
with a digital media player comprising a memory storing a plurality of channels of digital media files and a plurality of background animation files, wherein each channel is associated with a respective background animation file:
receiving a user selection of a channel;
displaying a channel name of the selected channel; and
playing the background animation file associated with the selected channel.

2. The method of claim 1 further comprising displaying information about a digital media file being played by the digital media player.

3. The method of claim 1 further comprising displaying information about a next digital media file in the channel.

4. The method of claim 1, wherein the digital media player receives the user selection of the channel through one of a next channel user input element and a previous channel user input element.

5. The method of claim 1, wherein the memory comprises a solid-state memory in a memory card that is removably connectable with the digital media player.

6. The method of claim 1, wherein the memory comprises a solid-state memory embedded in the digital media player.

7. The method of claim 1, wherein the digital media files comprise digital audio files.

8. The method of claim 1, wherein the channels are pre-loaded into the memory.

9. The method of claim 1, wherein at least one channel is user-defined.

10. A method for providing a user interface on a digital media player, the method comprising:
with a digital media player comprising a memory storing a plurality of channels of digital media files:
receiving a user selection of a channel;
displaying a channel name of the selected channel; and
displaying a visual representation of the plurality of channels, wherein a first indicia is used to represent the selected channel and a second indicia is used to represent the other channels.

11. The method of claim 10 further comprising:
receiving a user selection of a different channel; and
updating the visual representation of the plurality of channels to reflect the selection of the different channel.

12. The method of claim 10 further comprising displaying information about a digital media file being played by the digital media player.

13. The method of claim 10, wherein the digital media player receives the user selection of the channel through one of a next channel user input element and a previous channel user input element.

14. The method of claim 10 further comprising displaying information about a next digital media file in the channel.

15. The method of claim 10, wherein the memory comprises a solid-state memory in a memory card that is removably connectable with the digital media player.

16. The method of claim 10, wherein the memory comprises a solid-state memory embedded in the digital media player.

17. The method of claim 10, wherein the digital media files comprise digital audio files.

18. The method of claim 10, wherein the channels are pre-loaded into the memory.

19. The method of claim 10, wherein at least one channel is user-defined.

20. The method of claim 10, wherein the memory further stores a plurality of background animation files, wherein each channel is associated with a respective background animation file, and wherein the method further comprises playing the background animation file associated with the selected channel.
